(19) United States
(12) Patent Application Publication
(10) Pub. No.: US 2010/0309895 A1
(43) Pub. Date: Dec. 9, 2010

(54) DATA TRANSMISSION FROM A VEHICLE AND NETWORK REGULATION

(75) Inventors: Nicholas Hunn, Middlesex (GB); Timothy John Wheatley, Crowthorne (GB); Mahendra Tailor, Middlesex (GB); Andrew Dobbing, Buckinghamshire (GB)

Correspondence Address: HARNESS, DICKEY, & PIERCE, P.L.C, 7700 Bonhomme, Suite 400, ST. LOUIS, MO, 63105, US

(73) Assignee: EZURIO LIMITED, Woodburn Green, Buckinghamshire (GB)

(21) Appl. No.: 12/676,873

(22) PCT Filed: Sep. 5, 2008
(86) PCT No.: PCT/GB2008/050792

§ 371 Date: Jul. 27, 2010

(30) Foreign Application Priority Data
Sep. 6, 2007 (GB) 0717346.1

(51) Int. Cl. H04W 76/02; G01C 21/00; G01S 19/42; G06F 7/00; G06F 15/173

(52) U.S. Cl. 370/338; 701/207; 701/213; 701/33; 709/223

(57) ABSTRACT

The invention provides a method for transmitting data from a vehicle. The vehicle is provided with a monitoring apparatus (1). The monitoring apparatus (1) comprises (i) a navigation device (2) that can determine the vehicles position, (ii) a memory device (4), and (iii) a telecommunication device (9). The method further comprises recording a first list of locations on the memory-device so that the telecommunication device is activated in response to the vehicles position.

### FIELD OF THE INVENTION

The invention provides a method and apparatus for transmitting data from a vehicle. This invention further provides a method for regulating data sent in a network.

### BACKGROUND TO THE INVENTION

A variety of systems are already known for monitoring and reporting the behaviour of vehicles. WO 9811522 describes a system that uses a GPS antenna to determine the position of a vehicle and then transmits this information to a monitoring station using a radio transmitter. However, if a system needs to be able to upload data autonomously then existing solutions are often either prohibitively expensive or impose tight restraints on their use. A practical solution must offer a cheap and reliable way of transmitting data from the vehicles to the server. A system that is capable of uploading that data autonomously would be extremely desirable. Systems which provide vehicles with monitoring equipment are also prone to congestion when many devices try to connect to a server simultaneously. Any such system for monitoring vehicles will therefore have to address the problem of managing limited resources on a network.

### SUMMARY OF THE INVENTION

Viewed from a first aspect, the invention provides a method for transmitting data from a vehicle. The vehicle is provided with a monitoring apparatus that comprises:
(i) a navigation device that can determine the vehicle's position;
(ii) a memory device; and
(iii) a telecommunication device.

The method comprises storing in the memory device a list of locations together with an indication of the availability of telecommunication at those locations. The method further includes the step of comparing the current position of the vehicle to the stored locations and in response to the comparison activating the telecommunication device to attempt to establish telecommunication for data transmission.

In this way the invention provides a method and apparatus for transmitting data from a vehicle that will selectively attempt to connect and transmit the data. This selectiveness allows the apparatus to operate more efficiently, since it will waste less power attempting to connect where there is no suitable receiver in range, according to the stored location list. This selectiveness also allows the apparatus to operate more securely, since it can be restricted to attempting to connect only in specific locations where known and trusted receivers are available.

In addition the monitoring apparatus may optionally use the state of motion of the vehicle to determine whether it is likely to be able to access a connection point for sufficient time, or to trigger a search when it is moving slowly or stationary.

It may be that the list of locations comprises locations transmitted to the monitoring apparatus through the telecommunication device. For example, these locations may be transmitted to the monitoring apparatus by the owner or operator of the vehicle. As a further example, these locations may be transmitted to the monitoring apparatus by the person or organisation that is collecting the data transmitted by the monitoring apparatus. Any interested party can be given the relevant security details such as encryption and login details. The interested party can then exercise control over where the monitoring apparatus will attempt to establish telecommunication.

It may be that the list of locations comprises locations where the telecommunication device has successfully established telecommunication. Alternatively or in addition, it may be that the list of locations comprises locations where the telecommunication device has attempted and failed to establish telecommunication. This allows the apparatus to record and use a database of locations where it should try to make a connection and a further database of locations where it should not try to make a connection. Since most vehicles will spend the majority of their time in a small number of locations, these databases will become more complete over time and consequently allow the apparatus to become more efficient as it learns about its surrounding environment.

It may be that the telecommunication device comprises a wireless telecommunication device, such as a wireless local area network device. For example, the wireless local area network device may conform to at least one of the Institute of Electrical and Electronics Engineers' group of standards number 802.11. At the current time, the most widely used standard for wireless local area network devices is 802.11 g, and so this is the standard that monitoring devices would typically conform to. This is likely to change as new technologies emerge and are incorporated into the standards, for example in the forthcoming 802.11n. It may also sometimes be useful to provide other methods of connection, specifically other wireless methods of connection. For example, the monitoring apparatus may incorporate a Bluetooth device. Typically the device would also be provided with a further method of connection that is not wireless, such as a Universal Serial Bus (USB) socket, for use if no wireless connection is available or if the wireless device within the monitoring apparatus is impaired.

It may be that the navigation system comprises a receiver for electromagnetic signals, such as a Global Navigation Satellite System receiver. However, there are many navigation systems in operation that do not depend on satellites, and any navigation system suitable for determining the position of the monitoring apparatus with respect to telecommunications devices suitable for acting as receivers could be used. For example, the system could make use of radio signals originating on land, either instead of a Global Navigation Satellite System or to compliment one. However, at the current time it is most likely that the navigation system will comprise a Global Positioning System (GPS) receiver. GPS is both the cheapest system to implement and the one with the most global coverage at this time. However, this may change in the future and there is no reason why a different Global Navigation Satellite System such as the planned Galileo European Satellite Navigation System could not be used. Also, local services such as roadside location beacons can be used.

The navigation device, memory device and telecommunication device of the monitoring device may be integrated into a single unit. Alternatively they may not. Where it is not integrated into the single unit, the navigation device will usually be a user portable device. The navigation device will also usually provide location information to an occupant of the vehicle whilst the vehicle is in use. For example, a stand-along GPS device used by the driver of the vehicle for navigation may function as the navigation device in the invention. Similarly, a mobile phone that provides location services such as GPS can function as both the navigation device and the telecommunication device. If the devices are not integrated into the same unit then they may communicate through wired connections such as the vehicle's interface bus or through wireless connections such as Bluetooth.

It may be that the monitoring apparatus comprises an interface for the vehicle's on board diagnostic systems. This would allow the monitoring apparatus to gather more information about the vehicle, and hence provide a more detailed record of the vehicle's use and condition. It is desirable for the monitoring apparatus to upload this use information at regular intervals to a server. However, typically, the daily behaviour of vehicle users is such that there will be peaks in network traffic as a large proportion of monitoring devices attempt to upload their data, for example as vehicles return to a user's home and are able to connect to a home wireless network.

Viewed from a further aspect, the invention provides a method for regulating data traffic to a primary node in a network from at least two secondary nodes in the network. The method comprises assigning to a first secondary node a first recurring time period in which to establish communication with the primary node. The method also includes identifying instances of the first secondary node establishing communication with the primary node outside of the first recurring time period. In response to the identification of such instances, the method includes assigning to a second secondary node the first recurring time period in which to establish communication with the primary node and assigning to the first secondary node a different recurring time period in which to establish communication with the primary node.

In this way, the invention provides a method whereby a network can regulate the behaviour of the nodes so as to improve the efficiency of the network and to help reduce congestion. In particular, the invention provides a method for reducing congestion of a node, referred to here as the primary node which might be a server for example, which the secondary nodes need to connect to.

According to the method, a secondary node is provided with a first recurring time period in which to communicate with the primary node. If this recurring time period is convenient for the secondary node, it will continue to connect regularly during this period. However, if this period is inconvenient, the secondary node will be forced to connect to the primary node outside of the first recurring time period. In this case, the first recurring time period is assigned to a different secondary node, for whom the time period may be convenient and a different recurring time period is assigned to the first secondary node. By this method, over time, each secondary node is assigned a recurring time period that is convenient to that node. Furthermore the time periods can be distributed to minimise peak loads on the primary node.

The recurring time periods may recur regularly, for example daily, weekly, monthly or annually. Alternatively, a new future time period may be selected for the first secondary node according to some predefined selection criterion each time the secondary node establishes communication with the primary node. The secondary nodes may be provided with a single time period during which they are instructed to attempt to connect to the primary node, or they may be provided with a list of such time periods. This list may comprise an actual list of time periods sent to the secondary nodes, or it may comprise a set of rules from which the time periods can be calculated.

It may be that the time periods are chosen so as to avoid predicted peaks in the amount of data being sent to the primary node. This would be an effective way of reducing the peak load that the primary node experiences. However, the time periods may be chosen for other reasons, such as to avoid scheduled maintenance of the primary node.

It may be that the secondary nodes comprise a finite memory and data is stored on the finite memory and periodically uploaded to the primary node. It may further be that if the data stored on the finite memory of one of the secondary nodes is exceeds a predetermined level then that node will immediately attempt to establish communication with the primary node. This can help to prevent the finite memories of the secondary nodes becoming full and data being lost.

It may be that the second and subsequent nodes comprise a wireless telecommunication device. It may further be that the wireless telecommunication device comprises a wireless local area network device. It may also be that the wireless local area network device conforms to at least one of the Institute of Electrical and Electronics Engineers' group of standards number 802.11. As is explained above, at the current time, the most widely used standard for wireless local area network devices is 802.11 g, and so this is the standard that the secondary nodes would typically conform to. This is likely to change as new technologies emerge and are incorporated into the standards, for example in the forthcoming 802.11n. It may also sometimes be useful to provide other methods of connection, specifically other wireless methods of connection. For example, the secondary nodes may incorporate a Bluetooth device.

### BRIEF DESCRIPTION OF THE DRAWINGS

An embodiment of the invention will now be described, by way of example only, and with reference to the accompanying drawings, in which:

FIG. 1 is a block diagram of data transmission apparatus according to an embodiment of the invention when connected to a server through a local area network;

FIG. 2 is a block diagram showing a network according to an embodiment of the invention; and

FIG. 3 is a flowchart showing the behaviour of a server according to an embodiment of the invention.

### DETAILED DESCRIPTION OF EXEMPLARY EMBODIMENTS

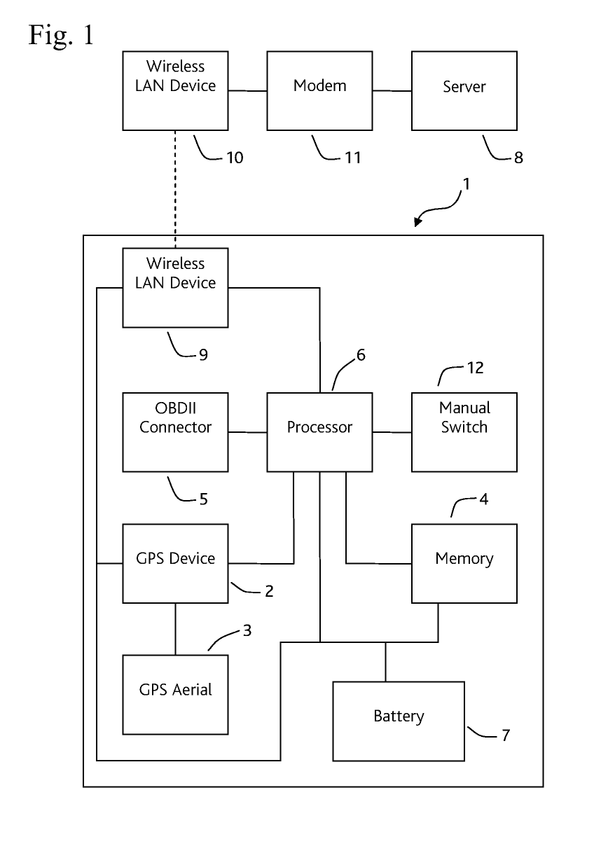

FIG. 1 shows a block diagram of data transmission apparatus according to an embodiment of the invention, where the apparatus is connected to the server through a local area network and the internet. The embodiment in FIG. 1 is a monitoring apparatus 1 provided by an insurance company to one of its customers. The customer installs the monitoring apparatus in their vehicle, so that the monitoring apparatus can record information about the use of the vehicle, such as how often, how far and how fast it is driven.

The monitoring apparatus 1 contains a Global Positioning System (GPS) device 2 provided with a GPS aerial 3 which allows the monitoring apparatus to record the vehicle's geographical movements to an internal memory 4. The monitoring apparatus 1 also contains an On Board Diagnostics II (OBDII) connector 5 which allows the monitoring apparatus 1 to connect to the vehicle's onboard computers and record their status to the internal memory 4. The activity of these components is coordinated by a central processor 6.

A Lithium-Ion (Li-Ion) battery 7 provides power to the components of the monitoring apparatus 1. The Li-Ion battery is charged from the vehicle's own battery while the vehicle is in use. Providing the monitoring apparatus 1 with an internal battery makes it possible to connect to a wireless network when the vehicle is turned off without an occupant. It also permits tamper detection circuitry to be active, so that any attempt to interfere with the apparatus can be detected and sent wirelessly to an external network.

This is an important feature, as drawing power from a vehicle's battery while its alarm is enabled will often set off the alarm, and the apparatus' Li-Ion battery helps to prevent this.

Over time, the monitoring apparatus builds up a database of information from the GPS data and data from the onboard computers on the use of the vehicle, this database is stored in the internal memory 4. In order that this database can be transmitted back to a server 8 operated by the insurance company, the monitoring apparatus 1 is also provided with an internal Wireless Local Area Network (WLAN) device 9. The internal WLAN device is designed according to the Institute of Electrical and Electronics Engineers standard number 802.11 g. When the vehicle is in range of a suitable wireless hotspot provided by a complementary WLAN device 10, the monitoring apparatus will connect to the remote middleware via a modem 11 or data connection through the complementary WLAN device 10, provided that: either the second WLAN device does not require a password; or the monitoring apparatus 1 has been provided with the necessary login information. The monitoring apparatus 1 will then connect to the server 8 and download or upload data, as required.

However, while searching for an appropriate hotspot, the internal WLAN device 9 is constantly drawing power from the Li-Ion battery 7. In order that power can be conserved, the monitoring apparatus 1 maintains a “white list” of geographical locations in the internal memory 4, at which it expects to be able to locate a wireless hotspot. The monitoring apparatus 1 compares the location information from the GPS device to the locations recorded in the memory 4 and searches for a match.

The monitoring apparatus 1 has three modes of operation. The monitoring apparatus can be switched between modes both by using a manual switch 12 accessible on its exterior as well as by the server 8 over the internet connection or the customer using a personal computer and connecting remotely through the internal WLAN device 9. In the first mode of operation, the internal WLAN device will be switched off by default. When the vehicle is in a location on the white list, the internal WLAN device is switched on, and the monitoring apparatus searches for an available hotspot.

Both the customer and the insurance company are able to add locations to the white list. The customer can connect to the monitoring apparatus 1 through their personal computer over a wireless network and add any locations they require, as well as providing any passwords that the hotspots in those locations need. For example, the customer might add their office and their home as locations at which to try and connect, so that the monitoring apparatus can connect through their office network during the day and their home network during the night. When a location is added to the white list a radius can be specified. The radius specifies how close to that location the vehicle has to be before the monitoring apparatus starts searching for hotspots. If the location is a house with a home wireless system, then the radius will probably be very small, since the hotspot will not extend far from the house. If the location is a public place such as a car park then there may be a wireless system installed that covers a large area, the radius can be correspondingly large.

Where the wireless system expands even further, such as a municipal wireless network, the radius may be ignored.

When the insurance company wishes to add a location to the white list, this location is stored on the server 8, and the monitoring apparatus 1 downloads the location data the next time it connects. The insurance company can then provide hotspots at convenient locations such as petrol stations. These hotspots can be secured against being hijacked for other uses with a password that is then supplied to the monitoring apparatus along with the updated white list of locations.

Customers may also update their lists by logging into a website which allows them to make entries into a database, which are subsequently downloaded to the apparatus the next time it makes a wireless connection. This is particularly useful where a user changes their home access point, as it allows changes to the apparatus without the need to remove it from the vehicle.

When the monitoring apparatus 1 is in its second mode of operation, it will scan for hotspots even when the vehicle is not at a location on the white list. It can be put into this mode by the customer, or it can switch to it automatically. The customer can change to the second mode if they are going to be away from their usual connection locations for a long time, for example if they are going on holiday. This prevents the internal memory filling up while waiting for the vehicle to return to a location on the white list and data being lost. The monitoring apparatus will also switch to its secondary mode automatically if the internal memory 4 is almost full, in order to upload information as quickly as possible. If the monitoring apparatus routinely needs to switch to the second mode of operation because it is too full, then an instruction will be sent from the server 8, causing it to switch to the second mode of connection permanently.

There is also a “black list” of locations stored in the internal memory 4 of the monitoring apparatus 1. The black list locations are places where the device should never attempt to connect, and the black list is used in the second mode of operation. The black list can be updated in the same way as the white list. The insurance company could use the list as a security measure, for example, to prevent any of their devices searching for a hotspot in an area where a bogus hotspot has been created. The insurance company could also black list large and remote areas known to be without hotspots, so that the monitoring apparatus did not continuously try to connect while being driven across a desert or through a mountain range.

In the third mode of operation, the monitoring apparatus 1 will attempt to connect in white list locations and will not attempt to connect in black list locations. The customer and the insurance company will be able to add locations to the two lists as in the first and second modes of operation. However, when the monitoring apparatus is in a location that is not on either list it will still attempt to scan for hotspots, provided that the vehicle is moving slowly enough or the Li-Ion battery has enough stored power. The monitoring apparatus then records whether it successfully contacted the server 8 in that location or not. If the server is contacted successfully, then the monitoring apparatus adds the location to the white list. Entries recorded to the white list in this way will be moved to the black list if the device finds that it can no longer find a useable hotspot at that location. Similarly, if the monitoring apparatus fails to contact the server in a location not on either list, then that location is added to the black list. Entries recorded to the black list in this way may only remain on the black list for a limited period of time, e.g. thirty days, before being removed, in order that the monitoring apparatus can test them for new hotspots periodically.

A monitoring apparatus 1 operating in the third mode can upload its collection of white list and black list locations to the server 8. The insurance company can then build up a map of available hotspots across the world, and provide this information to all of the vehicles it has provided with a device according to the invention. Such a map could have uses other than this, however. For example, a reliable and constantly updated map of publicly available hotspots could be made available to people wanting to connect to the internet in public spaces.

In order to keep download times to a minimum and preserve memory space, a vehicle would normally only be provided with an updated white list and black list for the areas that its GPS records indicated it was operating in. However, if a vehicle travels outside of these areas, the server 8 receives this information the first time that the vehicle successfully connects, and is able to respond by providing the white and black lists for the new area that the vehicle is in, so that the monitoring apparatus 1 can download and store the lists. Similarly, if the customer knows that they are about to travel to a new area, for example on holiday, then they can inform the insurance company who can provide the relevant information through their server 8 for the vehicle to download before the customer leaves.

The monitoring apparatus 1 will only scan for a hotspot when the vehicle is stationary or moving slowly. If the device detects that the vehicle is moving too fast for a wireless connection to be usefully established, it will not attempt to make such a connection. The monitoring apparatus may be able to determine the speed of the vehicle from the OBDII port, and this information will be used if it is available. However, the information reported on these ports is not generally consistent between different models of vehicle, and the information required may not be available. If it is not, the monitoring apparatus can determine the speed of the vehicle based upon the rate of change of the GPS coordinates.

The monitoring apparatus 1 does not scan continuously for a hotspot when the vehicle is stationary. Instead the monitoring apparatus scans intermittently and with decreasing frequency. For example if the vehicle is parked in a location on the white list then the monitoring apparatus 1 will scan for a hotspot immediately. If it fails to find one, then it will wait a minute before trying again. A second failure will cause it to wait five minutes, then half an hour, then an hour and so on. This means that the monitoring apparatus will still find a network even if it is temporarily unavailable, but will not waste too much power doing so. This behaviour can be modified by downloading a new connection strategy from the server.

The monitoring apparatus 1 will not attempt to connect to a wireless network if the Li-Ion battery 7 is too low on power. If this happens, the device will stop scanning for hotspots until the vehicle engine is restarted and the battery is recharged sufficiently.

It may sometimes be necessary for the customer or a representative of the insurance company to access the monitoring apparatus 1 when the vehicle is in a location on the black list. It may be necessary to access the monitoring apparatus in order to change the settings of the monitoring apparatus or to retrieve information after an accident, for example. To allow this to be done, the device 1 provides a standard USB port so that the device can be manually connected to a personal computer, if required. Other similar wired connections can be provided if necessary.

Following a successful transmission of data, the monitoring apparatus 1 will typically wait a minimum of one day before it attempts to connect to the server 8 again. Similarly, the monitoring apparatus need not attempt to connect to the server if the amount of data that it is storing is beneath a predetermined threshold. This ensures that a reasonable amount of data has built up between each transmission, and that the server is not barraged with a huge number of unnecessary attempts to connect. The monitoring apparatus will ignore the one day minimum and the minimum data threshold and attempt to connect to the server earlier if a week has passed since the last connection or the data it is storing exceeds a second, higher, predetermined threshold.

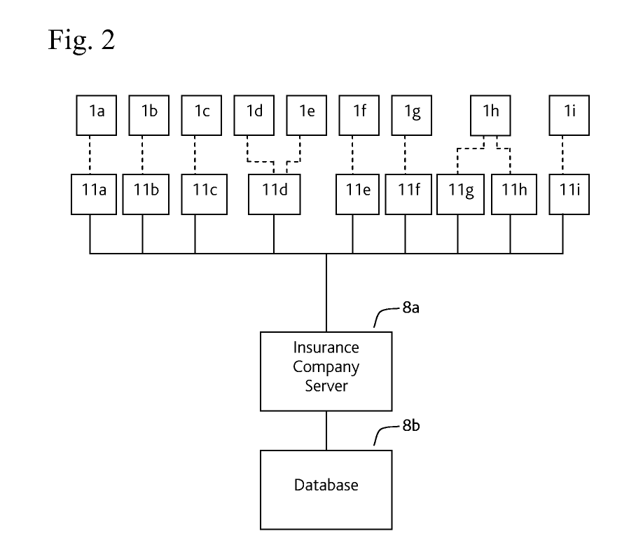

FIG. 2 shows a small network according to a second aspect of the invention. Monitoring devices 1a to 1i are provided for nine vehicles by the company that insures them. Each of these monitoring devices is similar to the monitoring apparatus illustrated in FIG. 1 in that they are provided with a WLAN device 9 and an internal memory 4. Each of the monitoring devices typically connects to the internet by one of the nine modems 11a to 11i. Through these modems the monitoring devices connect to an insurance company server 8a. As the fourth and fifth monitoring devices 1d and 1e are fitted on vehicles owned by the same person, both the fourth and the fifth monitoring apparatus can connect to the insurance company server 8a through the fourth modem 11d. Since the fourth modem 11d can easily transmit the data produced by two connections, this does not affect the behaviour of the network. The eighth monitoring apparatus 1h is within range of two modems on a normal day, the seventh modem 1g and the eighth modem 1h. To begin with, none of the communications devices 1a to 1h are given any restrictions on when they can try to connect to the server 8.

Secure, authenticated data packets are used for communication between the insurance company server 8a and the monitoring devices. When one of the monitoring devices 1a to 1i accesses the internet it will log into the insurance company server 8a where it has an account that is unique to that monitoring device. The monitoring device transmits a stored data file to the insurance company server 8a. The data file sent by the monitoring apparatus contains the monitoring device's records of vehicle use in an encrypted format. When the insurance company server 8a receives this file it decrypts, checks and stores the data in the database 8b before preparing an acknowledgement. The next time the monitoring device connects to the server 8a, it receives this acknowledgement and deletes the data that has now been successfully stored. The insurance company server 8a can also send instructions that change the behaviour of the monitoring device.

Until they receive an acknowledgement for data transmitted from the insurance company server 8a, the monitoring devices 1a to 1i will not delete the sent data, and will continue to send copies of the data to the insurance company server's address. This introduces redundancy into the system and prevents data being lost in the event that a file fails to arrive. Similarly, if the insurance company server 8a receives the same data twice, the database 8b will only retain one copy, once the insurance company server 8a has checked that the two sets of data are identical, but two acknowledgements will be sent. Thus, if an acknowledgement is lost, the monitoring device will still eventually be informed of the data's safe arrival.

Using this system, a complete transaction between a monitoring device and the database 8b may require both the monitoring device and the database 8b to access the server 8a several times.

When the system begins operating, there are no restrictions in place as to when the monitoring devices 1a to 1i can attempt to connect to the insurance company server 8a. Each monitoring device in this example will attempt to connect to the server at least once a day. Over several days of typical operation, the system may experience a peak of connections at 7:00 pm, coinciding with commuters arriving home from work. In order to reduce the number of attempted connections to the insurance company server 8a at these peak times, the insurance company server 8a divides the monitoring devices 1a to 1i into two groups, A and B. An application running on the insurance company server 8a can send instructions to all the monitoring devices. The monitoring devices in group B are instructed not to attempt to connect to the insurance company server 8a between 6:30 pm and 8:30 pm. All of the monitoring devices 1a to 1i will follow similar instructions unless the data stored on the internal memory 4 of a monitoring device exceeds a predetermined threshold; if this happens the monitoring device may be programmed to disregard the instructions and attempt to connect even during the 6:30 pm to 8:30 pm peak period.

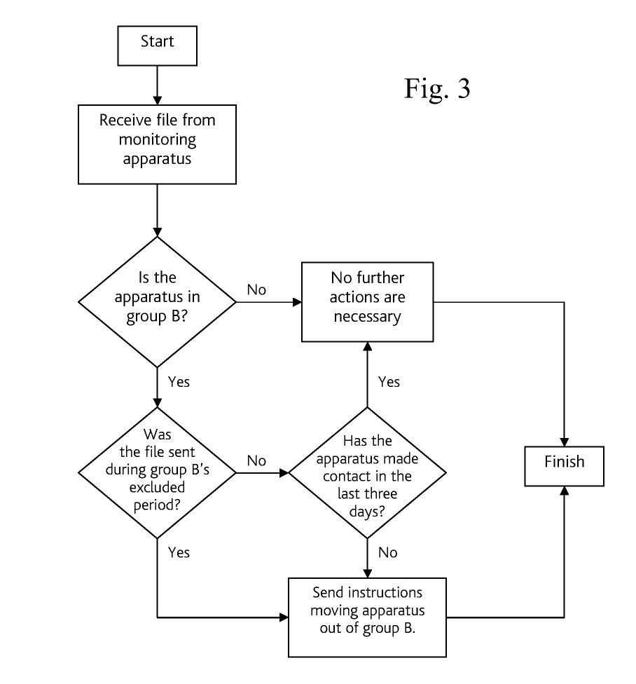

Initially, the monitoring devices 1a to 1i are assigned to groups A and B randomly. FIG. 3 is a flow chart showing how the insurance company server 8a will behave when the server receives a file from one of the monitoring devices 1a to 1i. If the monitoring device is in group A then there is no need for further action. If the monitoring device is in group B then the insurance company server 8a performs two simple checks. If the data was sent between 6:30 pm and 8:30 pm, in the period that group B is not supposed to transmit a message, then the data stored on the memory of the monitoring apparatus must have exceeded the threshold where the apparatus will disregard the instructions it has received. This would indicate that being in group B is causing problems with the monitoring device which would then be moved to group A. Similarly, a gap of more than three days in transmission would also result in a monitoring apparatus being moved from group B to group A in order that it can make contact more frequently. The insurance company server 8a would move the monitoring device from group B to group A by sending it an instruction removing the prohibition against connecting between 6:30 pm and 8:30 pm.

Normally, when one of the monitoring devices 1a to 1i is moved from group B to group A, the insurance company server 8a also moves another monitoring device from group A to group B, in order to maintain a constant number of monitoring devices in group B. The insurance company server 8a chooses monitoring devices that have never been in group B for moving to group B from group A, since this reduces the chance of further problems. However, it might be that all the monitoring devices have already been in group B and been rejected. If this is the case then the monitoring device that has gone the longest time since it was last in group B is moved back to group B.

Should the insurance company server 8a continue to experience too high a peak in activity between 6:30 pm and 8:30 pm, the insurance company server 8a moves more of the monitoring devices 1a to 1i from group A to group B. Again, those monitoring devices that have not been in group B before would be tried first, followed by those monitoring devices that have gone the longest time since they were last in group B.

Should the insurance company server 8a begin to experience a dip in activity between 6:30 pm and 8:30 pm, the insurance company server 8a moves some of the monitoring devices 1a to 1i from group B to group A.

Should the insurance company server 8a experience another peak at a different time of day, for example at 9:30 am, then the insurance company server 8a will create a third group C of monitoring devices that are instructed not to contact the server between 9:00 am and 11:00 am. Group C would be managed in the same way as group B, with the monitoring devices 1a to 1i moved in and out according to the same logic. The insurance company server 8a would avoid placing monitoring devices in both groups B and C wherever possible. Only when there were no monitoring devices in group A would the insurance company server 8a start placing devices in both groups B and C.

In the example given above, only nine monitoring devices 1a to 1i are used. This system is trivially small, and it would be easy for an observer to choose connection times for the monitoring devices that would allow the system to behave more efficiently than it would on automatic. However, it will be apparent to the reader that the system as described above is easily scaleable up to thousands or even millions of vehicles to achieve a relatively even distribution of network traffic.

1. A method for transmitting data from a vehicle provided with a monitoring apparatus that comprises (i) a navigation device that can determine the vehicle's position, (ii) a memory device, and (iii) a telecommunication device, the method comprising:
storing in the memory device a list of locations together with an indication of the availability of telecommunication at those locations;
comparing the current position of the vehicle to the stored locations; and
in response to the comparison activating the telecommunication device to attempt to establish telecommunication for data transmission.

2. A monitoring apparatus suitable for use in a vehicle comprising (i) a navigation device that can determine the vehicle's position, (ii) a memory device, and (iii) a telecommunication device, the monitoring apparatus being adapted to operate in accordance with the method of claim 1.

3. A method as claimed in claim 1, wherein the list of locations comprises locations transmitted to the monitoring apparatus through the telecommunication device, in use.

4. A method as claimed in claim 1, wherein the list of locations includes a record of locations where the telecommunication device has successfully established telecommunication.

5. A method as claimed in claim 1, wherein the list of locations includes a record of locations where the telecommunication device has attempted and failed to establish telecommunication.

6. A method as claimed in claim 1, wherein the telecommunication device comprises a wireless telecommunication device.

7. A method as claimed in claim 6, wherein the wireless telecommunication device comprises a wireless local area network device.

8. A method as claimed in claim 7, wherein the wireless local area network device conforms to at least one of the Institute of Electrical and Electronics Engineers' group of standards number 802.11.

9. A method as claimed in claim 1, wherein the navigation system comprises a Global Navigation Satellite System receiver.

10. A method as claimed in claim 1, wherein the monitoring apparatus comprises an interface for the vehicle's on board diagnostic systems.

11. A method as claimed in claim 1, wherein the navigation device, the memory device and the telecommunications device of the monitoring device are integrated into a single unit.

12. A method for regulating data traffic to a primary node in a network from at least two secondary nodes in the network, the method comprising:
assigning to a first secondary node a first recurring time period in which to establish communication with the primary node;
identifying instances of the first secondary node establishing communication with the primary node outside of the first recurring time period; and
in response to the identification of such instances assigning to a second secondary node the first recurring time period in which to establish communication with the primary node and assigning to the first secondary node a different recurring time period in which to establish communication with the primary node.

13. A method as claimed in claim 12, wherein the first time period is chosen so as to exclude predicted peaks in traffic to the primary node.

14. A method as claimed in claim 12, wherein the secondary nodes comprise a finite memory and data is stored on the finite memory and periodically uploaded to the primary node.

15. A method as claimed in claim 14, wherein if the amount of data stored on the finite memory of the first secondary node exceeds a predetermined level, the first secondary node establishes communication with the primary node.

16. A method as claimed claim 12, wherein the secondary nodes comprise a wireless telecommunication device.

17. A method as claimed in claim 16, wherein each wireless telecommunication device comprises a wireless local area network device.

18. A method as claimed in claim 17, wherein each wireless local area network device conforms to at least one of the Institute of Electrical and Electronics Engineers' group of standards number 802.11.

19. A monitoring apparatus suitable for use in a vehicle, the monitoring apparatus comprising:
a navigation device that can determine the vehicle's position;
a memory device operable for storing in the memory device a list of locations together with an indication of the availability of telecommunication at those locations;
a telecommunication device,
the monitoring apparatus being configured to be operable for:
comparing the current position of the vehicle to the stored locations; and
in response to the comparison, activating the telecommunication device to attempt to establish telecommunication for data transmission.

20. The monitoring apparatus as claimed in claim 19, wherein:
the list of locations comprises locations transmitted to the monitoring apparatus through the telecommunication device, in use; and/or
the list of locations includes a record of locations where the telecommunication device has successfully established telecommunication; and/or
the list of locations includes a record of locations where the telecommunication device has attempted and failed to establish telecommunication; and/or
the telecommunication device comprises a wireless telecommunication device comprising a wireless local area network device that conforms to at least one of the Institute of Electrical and Electronics Engineers' group of standards number 802.11; and/or
the navigation system comprises a Global Navigation Satellite System receiver; and/or
the monitoring apparatus comprises an interface for the vehicle's on board diagnostic systems; and/or
the navigation device, the memory device and the telecommunications device of the monitoring device are integrated into a single unit.
